(19) United States
(12) Patent Application Publication
(10) Pub. No.: US 2014/0165655 A1
(43) Pub. Date: Jun. 19, 2014

(54) Method For Manufacturing Glass Molding

(71) Applicant: Wataru Nakagawa, Itami-shi (JP)

(72) Inventor: Wataru Nakagawa, Itami-shi (JP)

(21) Appl. No.: 14/236,026

(22) PCT Filed: Jul. 3, 2012
(86) PCT No.: PCT/JP2012/066953

§ 371 Date: Jan. 29, 2014

(30) Foreign Application Priority Data
Jul. 29, 2011 (JP) 2011-166845

(51) Int. Cl. C03B 7/14

(52) U.S. Cl. CPC C03B 7/14
USPC 65/66

(57) ABSTRACT

A method for manufacturing a glass molding by using a molding device (100), the method including the steps of: supplying molten glass (82) from an outflow nozzle (12) onto an upper surface of a holding member (20), with an opening/closing portion (25) closed, and thereby forming a glass gob on an inner side of a drip pan ring (30); opening the opening/closing portion (25) after the glass gob reaches a prescribed amount, and thereby allowing the glass gob to fall; and press molding the glass gob by using a lower die (60) and an upper die (70), wherein in the step of supplying the molten glass (82) from the outflow nozzle (12) onto the upper surface of the holding member (20), a vibration generating device (40) vibrates the drip pan ring (30) at a prescribed frequency. A high-quality glass gob is formed and a high-precision glass molding is obtained.

### TECHNICAL FIELD

The present invention relates to a method for manufacturing a glass molding.

### BACKGROUND ART

At present, an optical element made of glass (hereinafter referred to as “optical glass element”) is widely used as a lens for a digital camera, an optical pickup lens for DVD and the like, a camera lens for a mobile phone, a coupling lens for optical communication, a lens for lighting, or various types of mirrors. Such optical glass element can be manufactured from a glass molding.

Japanese Laid-Open Patent Publication No. 2010-105871 (PTD 1) discloses a method for manufacturing a glass molding by first forming a glass gob (molten glass gob) from molten glass, and then, press molding the glass gob by using an upper die and a lower die.

### CITATION LIST

### Patent Document

PTD 1: Japanese Laid-Open Patent Publication No. 2010-105871

### SUMMARY OF INVENTION

### Technical Problem

An object of the present invention is to provide a method for manufacturing a glass molding, in which a higher-quality glass gob is formed and thereby a high-precision glass molding can be manufactured.

### Solution to Problem

A method for manufacturing a glass molding according to one aspect of the present invention is a method for manufacturing a glass molding by using a molding device, the molding device including: an outflow nozzle through which molten glass flows out; a holding member including an openable and closable opening/closing portion arranged below the outflow nozzle; an annular drip pan ring arranged on an upper surface side of the holding member; a vibration generating device for vibrating the drip pan ring; a lower die arranged on a lower surface side of the holding member; and an upper die, the method for manufacturing a glass molding including the steps of: supplying the molten glass from the outflow nozzle through an inner side of the drip pan ring onto the upper surface of the holding member, with the opening/closing portion closed, and thereby forming, increasing an amount of and growing a glass gob on the inner side of the drip pan ring; opening the opening/closing portion after the amount of the glass gob reaches a prescribed value, and thereby allowing the glass gob to fall from the upper surface of the holding member onto the lower die; and press molding the glass gob that has fallen onto the lower die, by using the lower die and the upper die, wherein in at least a part of the step of supplying the molten glass from the outflow nozzle through the inner side of the drip pan ring onto the upper surface of the holding member, the vibration generating device vibrates the drip pan ring at a prescribed frequency.

### Advantageous Effects of Invention

By adopting the aforementioned steps, there can be obtained a method for manufacturing a glass molding, in which a higher-quality glass gob is formed and thereby a high-precision glass molding can be manufactured.

### BRIEF DESCRIPTION OF DRAWINGS

FIG. 1 is a cross-sectional view showing a molding device used in a method for manufacturing a glass molding according to an embodiment.

FIG. 2 is a perspective view showing a holding member and a drip pan ring used in the method for manufacturing a glass molding according to the embodiment.

FIG. 3 is a cross-sectional view showing a first step of the method for manufacturing a glass molding according to the embodiment.

FIG. 4 is a cross-sectional view showing a second step of the method for manufacturing a glass molding according to the embodiment.

FIG. 5 is a plan view showing a third step of the method for manufacturing a glass molding according to the embodiment.

FIG. 6 is a plan view showing a fourth step of the method for manufacturing a glass molding according to the embodiment.

FIG. 7 is a cross-sectional view showing a fifth step of the method for manufacturing a glass molding according to the embodiment.

FIG. 8 is a first cross-sectional view showing a sixth step of the method for manufacturing a glass molding according to the embodiment.

FIG. 9 is a second cross-sectional view showing the sixth step of the method for manufacturing a glass molding according to the embodiment.

FIG. 10 is a cross-sectional view showing a seventh step of the method for manufacturing a glass molding according to the embodiment.

FIG. 11 is a cross-sectional view showing an eighth step of the method for manufacturing a glass molding according to the embodiment.

FIG. 12 is a cross-sectional view showing a ninth step of the method for manufacturing a glass molding according to the embodiment.

FIG. 13 is a cross-sectional view showing a tenth step of the method for manufacturing a glass molding according to the embodiment.

FIG. 14 is a cross-sectional view showing an eleventh step of the method for manufacturing a glass molding according to the embodiment.

### DESCRIPTION OF EMBODIMENTS

An embodiment based on the present invention will be described hereinafter with reference to the drawings. When the number, an amount or the like is mentioned in the embodiment described below, the scope of the present invention is not necessarily limited to that number, that amount or the like, unless otherwise specified. In the description of the embodiment, the same or corresponding portions are denoted by the same reference numerals, and redundant description will not be repeated.

(Molding Device 100)

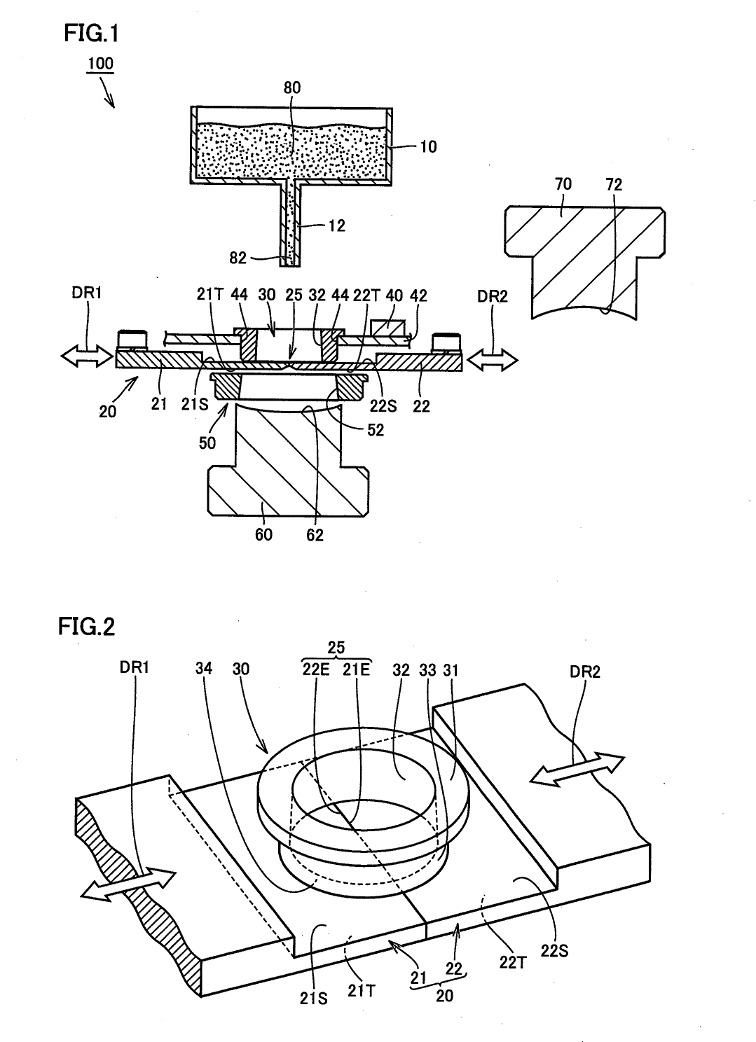

FIG. 1 is a cross-sectional view showing a molding device 100 used in a method for manufacturing a glass molding according to the embodiment. As shown in FIG. 1, molding device 100 includes an outflow nozzle 12, a holding member 20, a drip pan ring 30, a vibration generating device 40, a guide ring 50, a lower die 60, and an upper die 70. Molding device 100 can be used, for example, for fabricating a lens and the like of approximately 40 mmφ to 60 mmφ.

Outflow nozzle 12 has an inner diameter of, for example, φ3 mm. Outflow nozzle 12 is provided to hang down from a melting crucible 10. Molten glass 80 is stored in melting crucible 10. The temperature of molten glass 80 is, for example, 1300° C. A heating device (not shown) is provided around outflow nozzle 12. Outflow nozzle 12 is heated by the heating device, and thereby, molten glass 80 can flow out as molten glass 82.

FIG. 2 is a perspective view showing holding member 20 and drip pan ring 30. As shown in FIGS. 1 and 2, holding member 20 includes a first blade 21 and a second blade 22. First blade 21 and second blade 22 are made of, for example, an alloy of high heat resistance. An end face 21E (see FIG. 2) of first blade 21 and an end face 22E (see FIG. 2) of second blade 22 form an opening/closing portion 25.

First blade 21 is configured to be capable of reciprocating in the direction of an arrow DR1. Second blade 22 is configured to be capable of reciprocating in the direction of an arrow DR2. By the reciprocating movement of first blade 21 and second blade 22, opening/closing portion 25 is opened and closed. Holding member 20 is arranged such that opening/closing portion 25 is located below (directly below) outflow nozzle 12 (see FIG. 1).

Referring to FIG. 2, drip pan ring 30 is arranged on the upper surface (an upper surface 21S of first blade 21 and an upper surface 22S of second blade 22) side of holding member 20. Drip pan ring 30 is arranged to straddle opening/closing portion 25. Drip pan ring 30 is made of, for example, heat-resistant ceramics.

Drip pan ring 30 includes a flange portion 31 and a cylindrical portion 33, and is annularly formed as a whole. Cylindrical portion 33 is provided to hang from a lower surface of annularly formed flange portion 31. Drip pan ring 30 is fitted into an opening 44 (see FIG. 1) provided in a plate 42 (see FIG. 1). Although not shown in FIG. 2, plate 42 is actually arranged above holding member 20 to be spaced apart from and face holding member 20 as shown in FIG. 1.

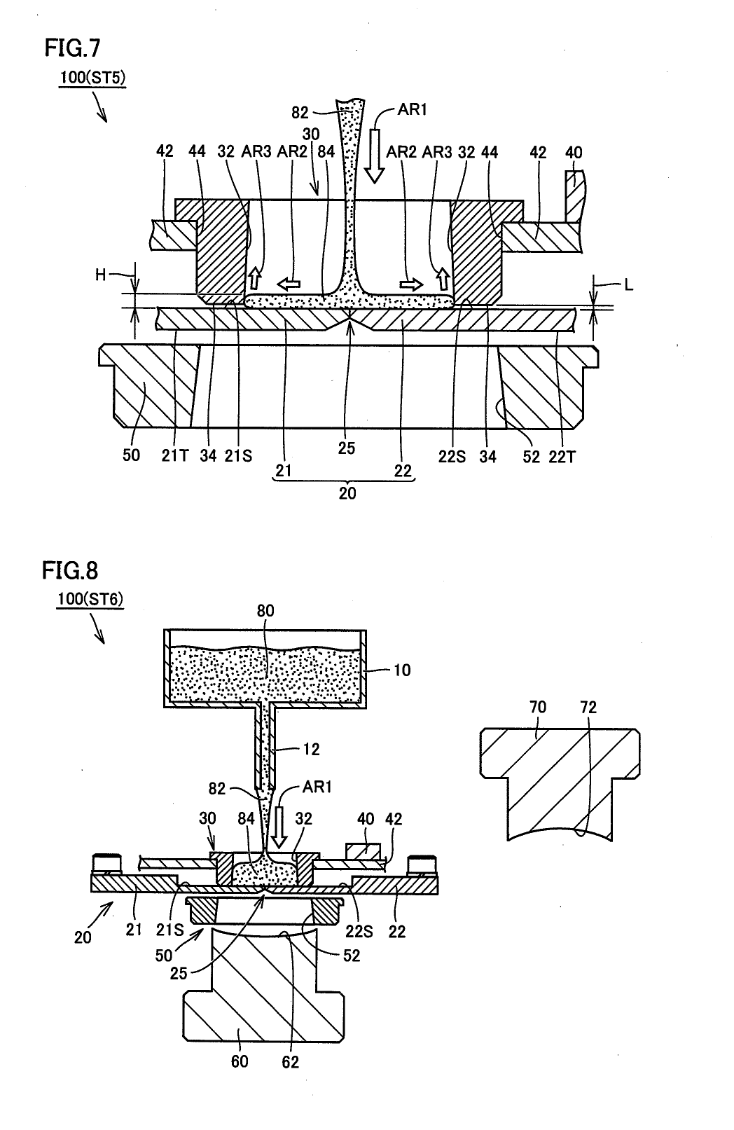

A minute spacing (see a spacing L in FIG. 7) may be provided between a lower surface 34 of cylindrical portion 33 (see FIG. 2) and an upper surface of holding member 20. This spacing (spacing L) is, for example, 0.5 mm to 1.0 mm. Although the details are described below, molten glass 82 (see FIG. 1) that has flown out through outflow nozzle 12 (see FIG. 1) is accumulated on the inner side (on the inner circumferential surface 32 side) of drip pan ring 30.

Vibration generating device 40 is provided on an upper surface of plate 42. Vibration generating device 40 includes an eccentric weight (not shown) therein. This eccentric weight is rotationally driven by supply of air and the like, and thereby, vibration generating device 40 generates vibrations (e.g., ultrasonic vibrations). Vibration generating device 40 may be formed by a piezoelectric element, an oscillator used in a buzzer and the like, or other elements. The vibrations generated by vibration generating device 40 are transmitted through plate 42 to drip pan ring 30. Vibration generating device 40 vibrates drip pan ring 30 at a vibration frequency of, for example, 282 Hz to 757 Hz.

Guide ring 50 is annularly formed as a whole. Guide ring 50 is arranged on the lower surface (a lower surface 21T of first blade 21 and a lower surface 22T of second blade 22) side of holding member 20. Guide ring 50 may be used as necessary. Although the details are described below, molten glass 82 (see FIG. 1) that has flown out through outflow nozzle 12 (see FIG. 1) is accumulated on the inner side (on the inner circumferential surface 52 side) of guide ring 50.

Lower die 60 is also arranged on the lower surface (lower surface 21T of first blade 21 and lower surface 22T of second blade 22) side of holding member 20. A molding surface 62 of lower die 60 is located on the opposite side of holding member 20 with guide ring 50 interposed therebetween. Lower die 60 is made of, for example, an ultrahard material containing tungsten carbide as a main ingredient. Lower die 60 is heated to a prescribed temperature (e.g., about 400° C.) by the heating device (not shown).

Upper die 70 is arranged at a position distant from melting crucible 10, holding member 20 and the like. Although the details are described below, press molding is performed by a molding surface 72 of upper die 70 and molding surface 62 of lower die 60. Upper die 70 is also made of, for example, an ultrahard material containing tungsten carbide as a main ingredient. Upper die 70 is also heated to a prescribed temperature (e.g., about 400° C.) by the heating device (not shown). The temperatures of lower die 60 and upper die 70 may be the same as each other, or may be different from each other. Molding surface 62 and molding surface 72 may be formed aspherically, or may be formed spherically.

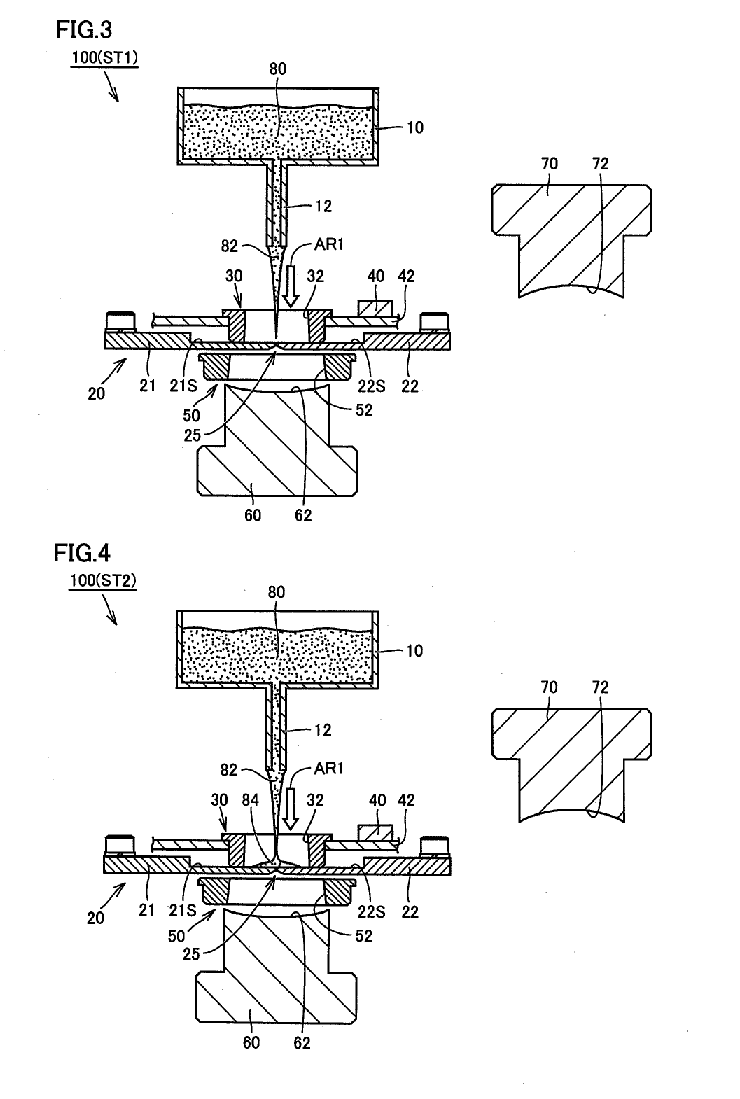

Molding device 100 (see FIG. 1) used in the method for manufacturing a glass molding according to the embodiment is configured as described above. Each step in the method for manufacturing a glass molding according to the embodiment will be sequentially described below with reference to FIGS. 3 to 14.

(Method for Manufacturing Glass Molding)

(First Step ST1)

Referring to FIG. 3, opening/closing portion 25 of holding member 20 is first in the closed state. Guide ring 50 and lower die 60 are arranged below opening/closing portion 25. In this state, outflow nozzle 12 is heated. Molten glass 82 flows out from a lower end of outflow nozzle 12 in a liquid line manner (see an arrow AR1). At this time, vibration generating device 40 may vibrate drip pan ring 30.

(Second Step ST2)

Referring to FIG. 4, molten glass 82 is supplied from the lower end of outflow nozzle 12 through the inner side of drip pan ring 30 onto the upper surface of holding member 20 (upper surface 21S of first blade 21 and upper surface 22S of second blade 22). Molten glass 82 is cooled by contact with holding member 20. Molten glass 82 forms a small glass gob 84 (glass gob 84 herein is in the state close to the state of molten glass 82 and most of glass gob 84 is melted). At this time, vibration generating device 40 may vibrate drip pan ring 30.

(Third Step ST3)

FIG. 5 is a plan view of holding member 20, drip pan ring 30 and the like when viewed from the outflow nozzle 12 (see FIG. 4 and the like) side. As shown in FIG. 5, molten glass 82 (see FIG. 4 and the like) continues to be further supplied to small glass gob 84 formed on the upper surface of holding member 20. The amount of the molten glass increases on the inner side of drip pan ring 30, and thus, the size of glass gob 84 increases. In other words, the glass gob grows.

By supply of molten glass 82 (see FIG. 4 and the like), glass gob 84 wets and spreads over the upper surface of holding member 20 substantially radially (see an arrow AR2). A diameter of an outer edge 84E of glass gob 84 increases substantially concentrically, and outer edge 84E of glass gob 84 gradually comes closer to inner circumferential surface 32 of drip pan ring 30. At this time as well, vibration generating device 40 may vibrate drip pan ring 30.

(Fourth Step ST4)

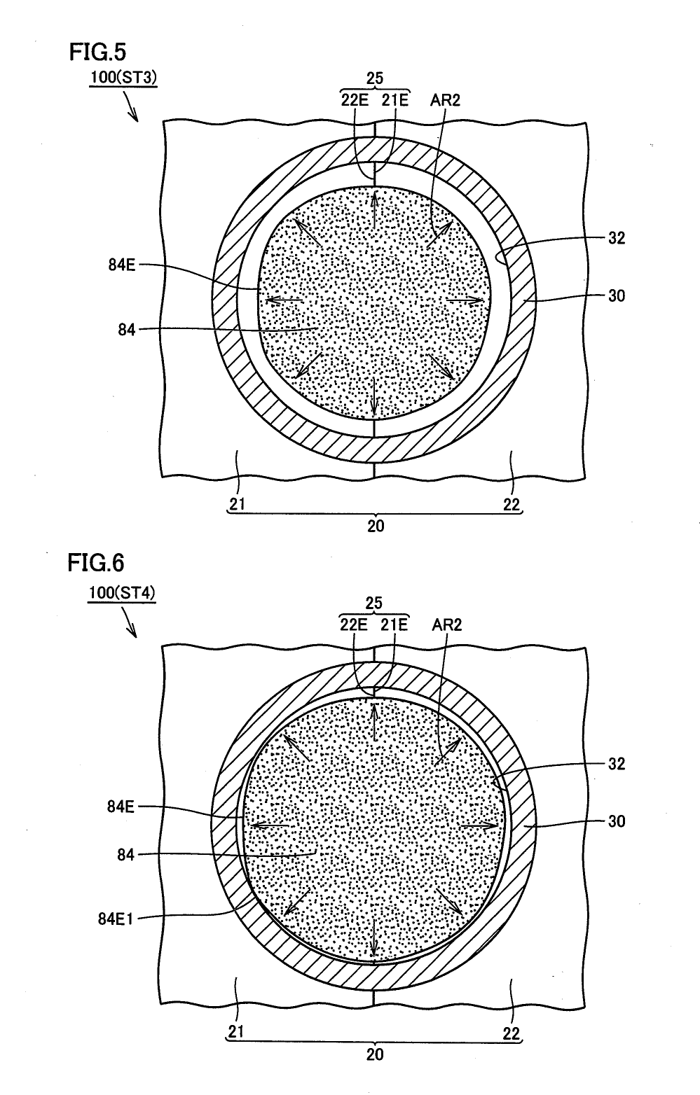

FIG. 6 is also a plan view of holding member 20, drip pan ring 30 and the like when viewed from the outflow nozzle 12 (see FIG. 4 and the like) side. As shown in FIG. 6, molten glass 82 (see FIG. 4 and the like) continues to be further supplied to small glass gob 84 formed on the upper surface of holding member 20. The amount of glass gob 84 continues to increase on the inner side of drip pan ring 30.

A part 84E1 of outer edge 84E of glass gob 84 wetting and spreading over the upper surface of holding member 20 comes into contact with inner circumferential surface 32 of drip pan ring 30 first. It is not very common that the diameter of outer edge 84E of glass gob 84 increases in a perfect circular manner, and the entire outer edge 84E of glass gob 84 hardly comes into contact with inner circumferential surface 32 of drip pan ring 30 simultaneously. Actually, only a part 84E1 (arbitrary location) of outer edge 84E of glass gob 84 comes into contact with inner circumferential surface 32 of drip pan ring 30 first. Glass gob 84 comes into contact with inner circumferential surface 32 of drip pan ring 30, and thereby, glass gob 84 starts to be cooled by drip pan ring 30.

Vibration generating device 40 may not vibrate drip pan ring 30 in the steps before this, and may start to vibrate drip pan ring 30 after at least a part 84E1 (arbitrary location) of outer edge 84E of glass gob 84 comes into contact with inner circumferential surface 32 of drip pan ring 30.

In addition, vibration generating device 40 may not vibrate drip pan ring 30 in the steps before this, and may start to vibrate drip pan ring 30 after the entire outer edge 84E of glass gob 84 comes into contact with inner circumferential surface 32 of drip pan ring 30.

(Fifth Step ST5)

Referring to FIG. 7, molten glass 82 continues to be further supplied to glass gob 84 formed on the upper surface of holding member 20. After the entire outer edge of glass gob 84 comes into contact with inner circumferential surface 32 of drip pan ring 30, glass gob 84 no longer wets and spreads over the upper surface of holding member 20 radially (in the direction of arrow AR2). As the amount of glass gob 84 increases, the liquid level of glass gob 84 rises gradually. The outer edge of glass gob 84 rises along inner circumferential surface 32 of drip pan ring 30 (see an arrow AR3).

Vibration generating device 40 may not vibrate drip pan ring 30 in the steps before this, and may start to vibrate drip pan ring 30 after a liquid level H of glass gob 84 formed on the inner circumferential surface 32 side of drip pan ring 30 reaches, for example, 1 mm to 2 mm. Liquid level H herein refers to a height from the upper surface of holding member 20 (upper surface 21 S of first blade 21 and upper surface 22S of second blade 22) to the liquid level of glass gob 84.

(Sixth Step ST6)

Referring to FIG. 8, molten glass 82 continues to be further supplied to glass gob 84 formed on the upper surface of holding member 20 (see arrow AR1). The amount of glass gob 84 further increases on the inner side of drip pan ring 30. At this time, vibration generating device 40 continues to vibrate drip pan ring 30.

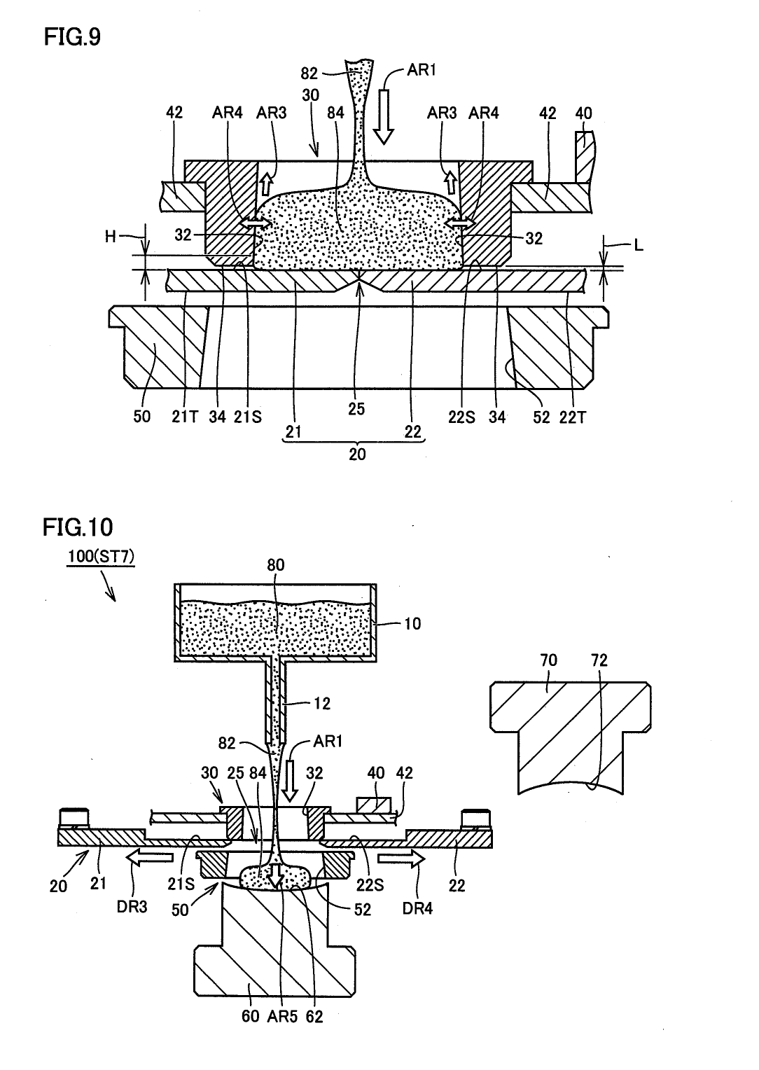

Referring to FIG. 9, as described above, when the amount of glass gob 84 increases, vibration generating device 40 vibrates drip pan ring 30. Due to the vibration of drip pan ring 30, glass gob 84 repeatedly comes into contact with or moves away from inner circumferential surface 32 of drip pan ring 30 (see an arrow AR4). As a result, the contact between glass gob 84 and inner circumferential surface 32 of drip pan ring 30 is less as compared with the case in which drip pan ring 30 is not vibrated.

(Seventh Step ST7)

Referring to FIG. 10, after the amount of glass gob 84 reaches a prescribed value on the inner side of drip pan ring 30, first blade 21 moves backward in the direction of an arrow DR3. Second blade 22 moves backward in the direction of an arrow DR4. Opening/closing portion 25 is opened. Glass gob 84 is no longer held by holding member 20 (upper surface 21S of first blade 21 and upper surface 22S of second blade 22). Glass gob 84 falls through opening/closing portion 25 onto molding surface 62 of lower die 60 (see an arrow AR5).

When glass gob 84 moves away from inner circumferential surface 32 of drip pan ring 30 and falls, vibration generating device 40 may also continue to vibrate drip pan ring 30. Even before and after glass gob 84 falls, molten glass 82 continues to be supplied to glass gob 84. The amount of glass gob 84 continues to increase.

(Eighth Step ST8)

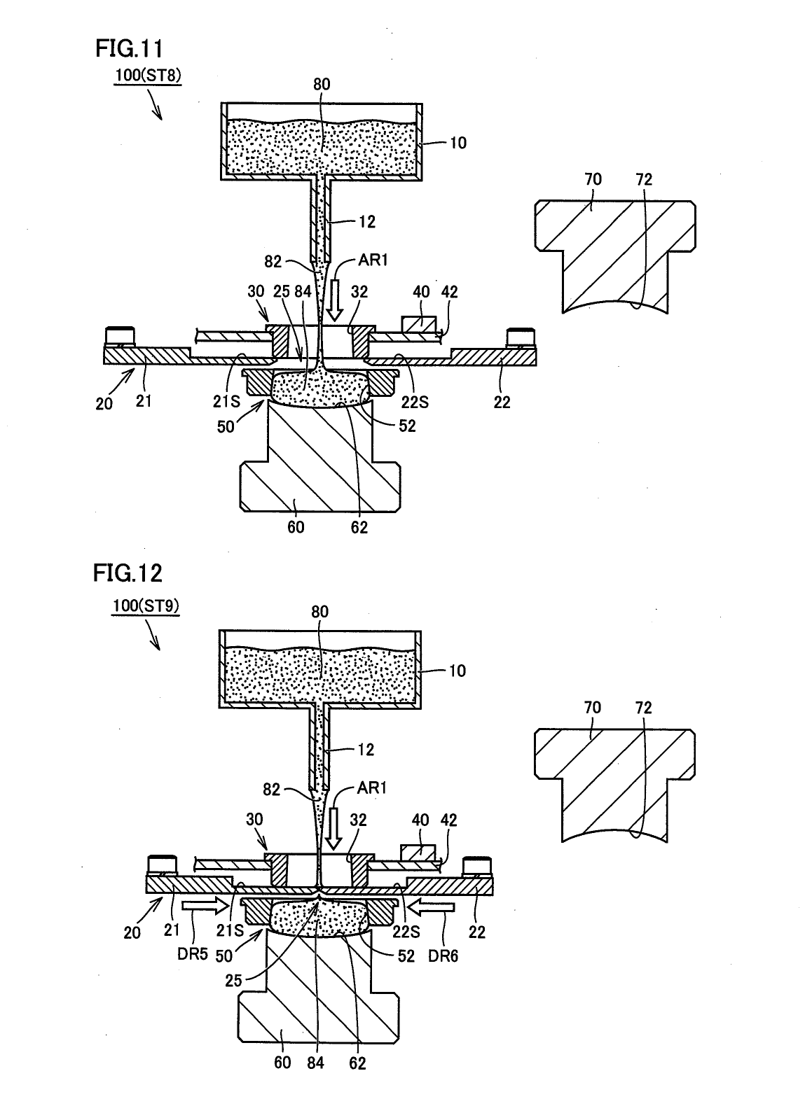

Referring to FIG. 11, molten glass 82 continues to be further supplied to glass gob 84 that has fallen onto molding surface 62 of lower die 60 (see arrow AR1). The amount of glass gob 84 continues to increase on the inner side (inner circumferential surface 52 side) of guide ring 50. Glass gob 84 further increases in its size and grows. As described above, guide ring 50 may be provided as appropriate, depending on the shape of molding surface 62 of lower die 60 and the like.

(Ninth Step ST9)

Referring to FIG. 12, after the amount of glass gob 84 reaches a prescribed value on the inner side of guide ring 50, first blade 21 moves forward in the direction of an arrow DRS. Second blade 22 moves forward in the direction of an arrow DR6. Opening/closing portion 25 is closed. The supply of molten glass 82 from outflow nozzle 12 to glass gob 84 is interrupted. Even after the supply of molten glass 82 from outflow nozzle 12 to glass gob 84 is interrupted, molten glass 82 continues to flow out through outflow nozzle 12.

(Tenth Step ST10)

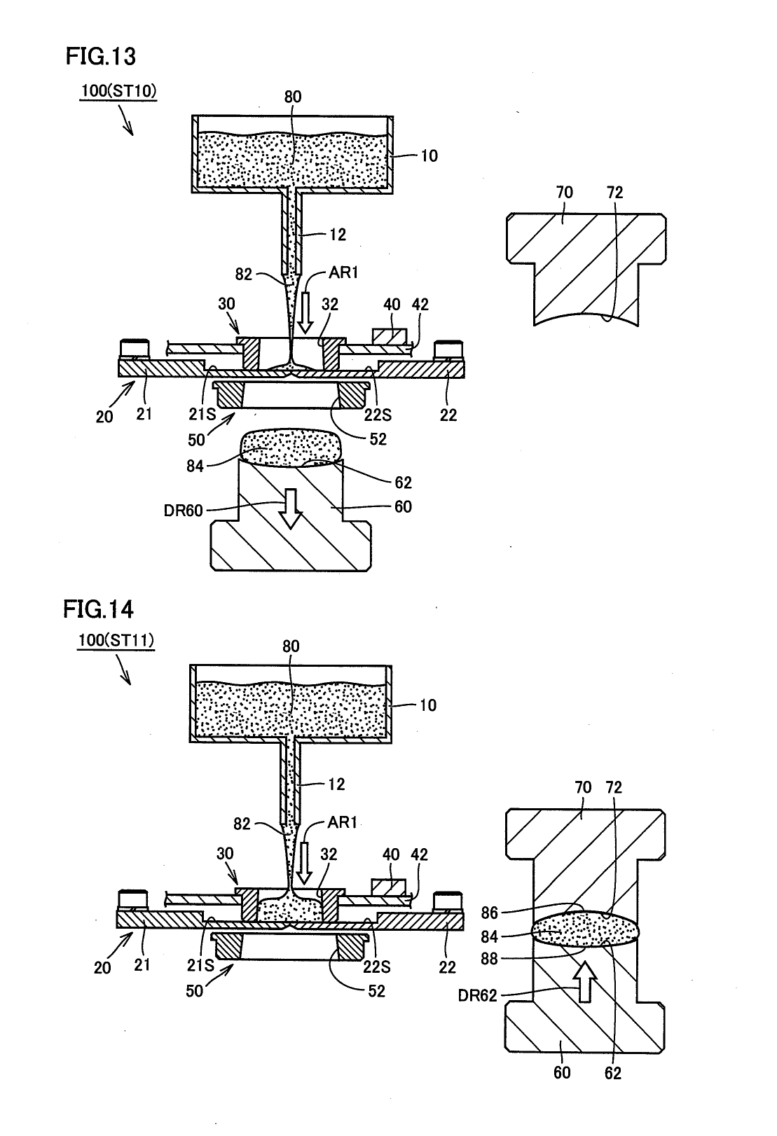

Referring to FIG. 13, after the supply of molten glass 82 from outflow nozzle 12 to glass gob 84 is interrupted, lower die 60 moves downward (see an arrow DR60). An air cylinder, a hydraulic cylinder, an electrically-driven cylinder using a servo motor, or the like may be used as means for moving lower die 60. The same is applied as well to upper die 70 described next. With the downward movement of lower die 60, glass gob 84 moves away from inner circumferential surface 52 of guide ring 50. A prescribed amount of glass gob 84 is formed on molding surface 62 of lower die 60.

(Eleventh Step ST11)

Referring to FIG. 14, after lower die 60 is arranged such that molding surface 62 of lower die 60 faces molding surface 72 of upper die 70, lower die 60 moves upward (see an arrow DR62). Upper die 70 may move downward, or lower die 60 and upper die 70 may move to come closer to each other. Glass gob 84 is press molded by molding surface 62 of lower die 60 and molding surface 72 of upper die 70.

An amount of pressing glass gob 84 may change with time, or may be fixed. This amount of pressing is determined depending on the size of glass gob 84 and the like. The amount of pressing may be set such that glass gob 84 is sufficiently firmly attached to the entire molding surface 72 of upper die 70.

Even if pressing by upper die 70 and lower die 60 is released, glass gob 84 is cooled and solidified until the shape of a molded surface 86 (transcription surface) of glass gob 84 is maintained. Glass gob 84 is cooled to, for example, a temperature close to the glass transition temperature (Tg) for several tens of minutes, although it varies depending on the material of glass gob 84, the size of glass gob 84, the shape of glass gob 84, or the required molding accuracy. Thereafter, pressing of glass gob 84 is released.

As described above, a glass molding is obtained from glass gob 84. The glass molding has molded surface 86 with high molding accuracy that is formed on the upper die 70 side. The obtained glass molding is separated from upper die 70 and lower die 60 by prescribed suction means (not shown). A molded surface 88 (on the lower die 60 side) of the obtained glass molding is processed as appropriate to conform to the shape of a device to which this glass molding is attached, and the like.

(Function and Effect)

It is assumed that the method for manufacturing a glass molding according to the embodiment is used (performed) a plurality of times. In this case, drip pan ring 30 in molding device 100 is also used a plurality of times. In drip pan ring 30, the supply of molten glass 82 to the inner side of drip pan ring 30 and the movement of glass gob 84 (molten glass 82) away from drip pan ring 30 due to falling of glass gob 84 are repeated a plurality of times.

When the same glass molding is obtained, the liquid level of glass gob 84 on the inner circumferential surface 32 side of drip pan ring 30 is the same each time. At the liquid level (top portion) of glass gob 84, volatiles (adherent produced by volatilization) of molten glass 82 adhere easily to inner circumferential surface 32 of drip pan ring 30. Falling of glass gob 84 located on the inner side of drip pan ring 30 becomes difficult.

In contrast, in the method for manufacturing a glass molding according to the embodiment, vibration generating device 40 vibrates drip pan ring 30 when the amount of glass gob 84 increases on the inner side of drip pan ring 30.

Due to the vibration of drip pan ring 30, glass gob 84 repeatedly comes into contact with or moves away from inner circumferential surface 32 of drip pan ring 30 (see arrow AR4 in FIG. 9). The contact state between glass gob 84 and inner circumferential surface 32 of drip pan ring 30 is less as compared with the case in which drip pan ring 30 is not vibrated. As a result, the volatiles of molten glass 82 do not adhere easily to inner circumferential surface 32 of drip pan ring 30.

It is possible to effectively suppress the state in which falling of glass gob 84 located on the inner side of drip pan ring 30 becomes difficult. For example, falling of glass gob 84 in an inclined manner is suppressed. Drawing of foam (bubble) between glass gob 84 and molding surface 62 of lower die 60 when glass gob 84 comes into contact with molding surface 62 of lower die 60 is also suppressed.

Since drawing of foam does not take place, glass gob 84 can be cooled evenly (uniformly) by molding surface 62 of lower die 60. Occurrence of sink at glass gob 84 on molding surface 62 of lower die 60 is also suppressed. Therefore, in the method for manufacturing a glass molding according to the embodiment, a higher-quality glass gob can be formed and a high-precision glass molding can be obtained.

As described above, the contact state between glass gob 84 and inner circumferential surface 32 of drip pan ring 30 when drip pan ring 30 is vibrated is less as compared with the case in which drip pan ring 30 is not vibrated. The temperature difference between the central portion and the outer circumferential portion in glass gob 84 is also reduced. In the method for manufacturing a glass molding according to the embodiment, in this regard as well, a higher-quality glass gob can be formed, and as a result, a high-precision glass molding can be obtained.

In addition, the volatiles of molten glass 82 do not adhere easily to inner circumferential surface 32 of drip pan ring 30. Entry of the volatiles of molten glass 82 into glass gob 84 at the time of manufacturing a glass molding next time is also suppressed. In the method for manufacturing a glass molding according to the embodiment, in this regard as well, a higher-quality glass gob can be formed, and as a result, a high-precision glass molding can be obtained.

As described above, vibration of drip pan ring 30 may be started after the entire outer edge 84E of glass gob 84 comes into contact with inner circumferential surface 32 of drip pan ring 30. More preferably, vibration of drip pan ring 30 may be started after liquid level H of glass gob 84 formed on the inner circumferential surface 32 side of drip pan ring 30 reaches, for example, 1 mm to 2 mm.

With these configurations, wetting and spreading of glass gob 84 can be made uniform, and the contact state between glass gob 84 and inner circumferential surface 32 of drip pan ring 30 can be made uniform. Not only is it possible to reduce the temperature difference at a portion close to the outer edge of glass gob 84, but also glass gob 84 has a uniform thickness. A higher-quality glass gob can be formed, and as a result, a high-precision glass molding can be obtained.

Although the embodiment based on the present invention has been described above, the embodiment disclosed herein is illustrative and not limitative in any respect. The technical scope of the present invention is defined by the terms of the claims, and is intended to include any modifications within the scope and meaning equivalent to the terms of the claims.

The method for manufacturing a glass molding described above is a method for manufacturing a glass molding by using a molding device, the molding device including: an outflow nozzle through which molten glass flows out; a holding member arranged below the outflow nozzle; an annular drip pan ring arranged on an upper surface side of the holding member; a vibration generating device for vibrating the drip pan ring; a lower die arranged on a lower surface side of the holding member; and an upper die, the method for manufacturing a glass molding including the steps of: supplying the molten glass from the outflow nozzle through an inner side of the drip pan ring onto the upper surface of the holding member, and thereby forming, increasing an amount of and growing a glass gob on the inner side of the drip pan ring; after the amount of the glass gob reaches a prescribed value, allowing the glass gob to fall from the upper surface of the holding member onto the lower die; and press molding the glass gob that has fallen onto the lower die, by using the lower die and the upper die, wherein in at least a part of the step of supplying the molten glass from the outflow nozzle onto the upper surface of the holding member, the vibration generating device vibrates the drip pan ring at a prescribed frequency. The holding member includes an openable and closable opening/closing portion arranged below the outflow nozzle. The holding member receives the molten glass, with the opening/closing portion closed, and allows the glass gob to fall onto the lower die by opening the opening/closing portion. The aforementioned configuration of the holding member can be adopted.

As one example, the vibration generating device vibrates the drip pan ring, after the molten glass is supplied from the outflow nozzle onto the upper surface of the holding member and at least a part of an outer edge of the molten glass wetting and spreading over the upper surface of the holding member comes into contact with an inner circumferential surface of the drip pan ring.

As another example, the vibration generating device vibrates the drip pan ring, after the molten glass is supplied from the outflow nozzle onto the upper surface of the holding member and an entire outer edge of the molten glass wetting and spreading over the upper surface of the holding member comes into contact with an inner circumferential surface of the drip pan ring.

As still another example, the vibration generating device vibrates the drip pan ring, after the molten glass is supplied from the outflow nozzle onto the upper surface of the holding member and an entire outer edge of the molten glass wetting and spreading over the upper surface of the holding member comes into contact with an inner circumferential surface of the drip pan ring and a liquid level of the molten glass reaches a prescribed value.

As a further example, the vibration generating device also vibrates the drip pan ring when the opening/closing portion is opened to allow the glass gob to fall from the upper surface of the holding member onto the lower die.

### REFERENCE SIGNS LIST

10 melting crucible; 12 outflow nozzle; 20 holding member; 21 first blade; 21E, 22E end face; 21S, 22S upper surface; 21T, 22T, 34 lower surface; 22 second blade; 25 opening/closing portion; 30 drip pan ring; 31 flange portion; 32, 52 inner circumferential surface; 33 cylindrical portion; 40 vibration generating device; 42 plate; 44 opening; 50 guide ring; 60 lower die; 62, 72 molding surface; 70 upper die; 80, 82 molten glass; 84 glass gob; 84E outer edge; 84E1 part; 86, 88 molded surface; 100 molding device; AR1, AR2, AR3, AR4, AR5, DR60, DR62 arrow; H liquid level; L spacing; ST1 first step; ST2 second step; ST3 third step; ST4 fourth step; ST5 fifth step; ST6 sixth step; ST7 seventh step; ST8 eighth step; ST9 ninth step; ST10 tenth step; ST11 eleventh step.

1. A method for manufacturing a glass molding by using a molding device (100),
said molding device comprising:
an outflow nozzle (12) through which molten glass (82) flows out;
a holding member (20) including an openable and closable opening/closing portion (25) arranged below said outflow nozzle;
an annular drip pan ring (30) arranged on an upper surface (21S, 22S) side of said holding member;
a vibration generating device (40) for vibrating said drip pan ring;
a lower die (60) arranged on a lower surface (21 T, 22T) side of said holding member; and
an upper die (70),
the method for manufacturing a glass molding comprising the steps of:
supplying said molten glass from said outflow nozzle through an inner side of said drip pan ring onto said upper surface of said holding member, with said opening/closing portion closed, and thereby forming, increasing an amount of and growing a glass gob (84) on the inner side of said drip pan ring;
opening said opening/closing portion after the amount of said glass gob reaches a prescribed value, and thereby allowing said glass gob to fall from said upper surface of said holding member onto said lower die; and
press molding said glass gob that has fallen onto said lower die, by using said lower die and said upper die, wherein
in at least a part of the step of supplying said molten glass from said outflow nozzle through the inner side of said drip pan ring onto said upper surface of said holding member, said vibration generating device vibrates said drip pan ring at a prescribed frequency.

2. The method for manufacturing a glass molding according to claim 1, wherein
said vibration generating device (40) vibrates said drip pan ring (30), after said molten glass is supplied from said outflow nozzle onto said upper surface of said holding member and at least a part of an outer edge of said molten glass wetting and spreading over said upper surface of said holding member comes into contact with an inner circumferential surface of said drip pan ring (30).

3. The method for manufacturing a glass molding according to claim 1, wherein
said vibration generating device (40) vibrates said drip pan ring (30), after said molten glass is supplied from said outflow nozzle onto said upper surface of said holding member and an entire outer edge of said molten glass wetting and spreading over said upper surface of said holding member comes into contact with an inner circumferential surface of said drip pan ring (30).

4. The method for manufacturing a glass molding according to claim 1, wherein
said vibration generating device (40) vibrates said drip pan ring (30), after said molten glass is supplied from said outflow nozzle onto said upper surface of said holding member and an entire outer edge of said molten glass wetting and spreading over said upper surface of said holding member comes into contact with an inner circumferential surface of said drip pan ring (30) and a liquid level of said molten glass reaches a prescribed value.

5. The method for manufacturing a glass molding according to claim 1, wherein
said vibration generating device (40) also vibrates said drip pan ring (30) when said opening/closing portion is opened to allow said glass gob (84) to fall from said upper surface of said holding member onto said lower die.

6. The method for manufacturing a glass molding according to claim 1, wherein
said glass gob (84) is grown by, after falling of said glass gob (84) onto said lower die, further supplying said molten glass from said outflow nozzle onto said lower die and increasing an amount of said molten glass, with said opening/closing portion opened.

7. The method for manufacturing a glass molding according to claim 1, wherein
said drip pan ring (30) is ultrasonically vibrated by said vibration generating device.
